(19) United States
(12) Patent Application Publication
(10) Pub. No.: US 2026/0122550 A1
(43) Pub. Date: Apr. 30, 2026

(54) METHOD, APPARATUS AND SYSTEM FOR SUPPORTING SERVERLESS COMPUTING IN MOBILE NETWORK

(71) Applicant: FOUNDATION OF SOONGSIL UNIVERSITY-INDUSTRY COOPERATION, Seoul (KR)

(72) Inventor: Young Han KIM, Seoul (KR)

(73) Assignee: FOUNDATION OF SOONGSIL UNIVERSITY-INDUSTRY COOPERATION, Seoul (KR)

(21) Appl. No.: 18/982,508

(22) Filed: Dec. 16, 2024

(30) Foreign Application Priority Data
Oct. 29, 2024 (KR) 10-2024-0149130
Nov. 26, 2024 (KR) 10-2024-0170862

(51) Int. Cl. H04W 40/24; H04W 24/08

(52) U.S. Cl. CPC H04W 40/246; H04W 24/08

(57) ABSTRACT

A method, apparatus and system for supporting serverless computing in a mobile network. A serverless computing support apparatus in a mobile network comprises a processor; and a memory connected to the processor, wherein the memory includes program instructions, executed by the processor, perform operations comprising receiving computing and network metrics pre-collected from each MEC server function, and mobile underlay network metrics collected from a network data analytics function (NWDAF) from a serverless computing aware function (SCAF) included in a mobile core network, and determining serverless service instance deployment information including the number of pre-warming serverless service instances and one or more MEC servers on which the service instances are to be placed by using a serverless orchestration algorithm with reference to the metrics.

### TECHNICAL FIELD

The present invention relates to a method, apparatus, and system for supporting serverless computing in a mobile network, and more particularly, to a method and apparatus for dynamically establishing a protocol data unit session for a user equipment (UE) request targeting a serverless computing service running on a mobile edge computing (MEC) site, in relation to the field of mobile network traffic steering.

### BACKGROUND ART

Serverless computing is a service deployment paradigm that can provide a dynamic automatic scale-up function of resources allocated to services according to actual service demand.

In serverless computing, if there are no service requests, the number of service instances can be reduced to 0, which can minimize the deployment resource cost of the service provider.

However, if the service demand increases, it may take a long time to initialize new service instances, which may cause delays, which is called the cold start problem of serverless computing.

To solve the cold start problem, a common method applied to various serverless computing orchestration and deployment algorithms is to pre-warm serverless service instances before actual request traffic arrives. Based on the expected upcoming request demand for serverless services and the current resource usage conditions of the serverless computing site, the serverless orchestration algorithm pre-initializes an appropriate number of serverless service instances and determines an appropriate deployment among various computing sites. When the actual request arrives, the cold start period is avoided and the serverless service instances are already ready to handle user requests.

To apply pre-warmed serverless orchestration methods in mobile edge networks, the mobile network control plane should be aware of the deployment and request serving capability of pre-warmed serverless service instances.

Without this information, UE requests may be routed to MEC sites that do not have pre-warmed serverless service instances or to MEC sites that have already reached their maximum request-serving capability. In both cases, new service instances are automatically scaled up, resulting in cold start problems.

Current mobile edge computing capabilities standardized by ETSI 3GPP lack support for steering UE requests to MEC sites with pre-warmed serverless service instances. ETSI 3GPP Technical Specification (TS) 23.501 defines application function (AF) traffic impacts to enable mobile networks to steer UE requests to optimal MEC sites.

FIG. 1 illustrates all ETSI 3GPP-defined MEC-related information that can be provided in an AF traffic impact request.

Referring to FIG. 1, the target application of an AF traffic impact request can be provided in terms of an application identifier (ID), a domain name system (DNS), a fully qualified domain name (FQDN), a data network name (DNN), optional network slice selection assistance information (NSSAI) and a public land mobile network (PLMN) identifier.

The optimal MEC site for steering the UE request can be provided in terms of a data network access identifier (DNAI), the edge application server (EAS) IP address, and the corresponding N6 traffic information.

The UE affected by the AF traffic impact request can be determined as all UEs, a group of UEs, or an individual UE. There are two drawbacks when using this information in a mobile network serverless edge computing orchestration environment.

The first drawback is the lack of information on pre-warmed serverless service instance deployment and request-serving capabilities. EAS information in the defined AF traffic impact request information can only specify MEC sites that host pre-warmed serverless service instances.

This allows the mobile network to avoid directing UE requests to MEC sites that do not have pre-warmed serverless service instances. The additional information required is the maximum requested serving capacity of the pre-warmed serverless instances running at the MEC site. This information allows the mobile network control plane to properly load balance UE requests between MEC sites that have pre-warmed serverless instances.

The second drawback lies in how the UEs affected by the AF traffic impact request are defined. If the target UE identifier is all UEs, steering all UE requests targeting the same serverless service to the same pre-warmed serverless service instance may result in exceeding the maximum serving capacity, leading to new instance initialization and cold start problems.

On the other hand, if the target UE identifier is an individual UE or a group of UEs, the AF needs UE information to specify this in the target UE identifier information field. Since the AF is on the edge side, the AF can have this information only after the UE request reaches the MEC site. The cold start problem may occur when the request arrives and during the AF traffic impact process.

### DISCLOSURE

### Technical Issues

In order to solve the problems of the above-mentioned prior art, the present invention proposes a method, apparatus, and system for supporting serverless computing in a mobile network that can prevent the serverless cold start problem.

### Technical Solution

In order to achieve the above object, according to one embodiment of the present invention, a method for supporting serverless computing in a mobile network, comprises transmitting, by a serverless computing aware function (SCAF) included in a mobile core network function, computing and network metrics pre-collected from each MEC server to an MEC orchestrator; transmitting, by the SCAF, mobile underlay network metrics collected from a network data analytics function (NWDAF) to the MEC orchestrator; determining, by the MEC orchestrator, serverless service instance deployment information including the number of pre-warming serverless service instances and one or more MEC servers on which the service instances are to be placed by using a serverless orchestration algorithm with reference to the metrics; preparing, by the one or more MEC servers, serverless service instances according to the determined deployment information; and exchanging, by an edge application server discovery function (EASDF) included in the function of the mobile core network, a PDU session and the deployment information with the SCAF in response to a serverless service request from a user equipment (UE), to establish a data plane routing path for the UE.

The serverless orchestration algorithm may determine pre-warmed service instance deployment information for preparing future request traffic by using a requested traffic volume, an UE location, and MEC site resource status prediction or mathematical analysis result as input data.

The MEC orchestrator may transmit the deployment information to one or more MEC servers through the MEC platform manager, and the FaaS framework running on one or more MEC servers may perform a serverless service instance deployment task to prepare a required number of pre-warmed service instances.

A session management function (SMF) included in the mobile core network function may provide a location of the UE and service domain name to the SCAF after receiving a PDU session establishment request for a serverless service of the UE, and the SCAF may determine a destination by considering computing resource consumption and request provision status of a current serverless service updated by a computing metrics agent of each MEC server.

The SCAF may determine one of a plurality of MEC servers, in which a pre-warmed serverless service instance capable of providing more available requests is prepared, as a target MEC server.

The SCAF may determine a target MEC server to provide a serverless service to the UE by calculating an expected service delay based on network bandwidth and computing resource consumption when there is no MEC server prepared with pre-warmed serverless service instances capable of providing more available requests.

According to another aspect of the present invention, a system for supporting serverless computing in a mobile network comprises an MEC orchestrator that determines serverless service instance deployment information including the number of pre-warmed serverless service instances and one or more MEC servers on which the service instances are to be placed using a serverless orchestration algorithm; and a serverless computing aware function (SCAF) included in a mobile core network function, and that transmits computing and network metrics pre-collected from each MEC server and mobile underlay network metrics collected from a network data analytics function (NWDAF) for determining the serverless service instance deployment information to the MEC orchestrator, wherein the one or more MEC servers prepare serverless service instances according to the determined deployment information, wherein an edge application server discovery function (EASDF) included in the mobile core network function exchanges a PDU session and the deployment information with the SCAF according to a serverless service request from a user equipment (UE), thereby establishing a data plane routing path for the UE.

According to another aspect of the present invention, a serverless computing support apparatus in a mobile network comprises a processor; and a memory connected to the processor, wherein the memory comprises program instructions, executed by the processor, performs operations comprising receiving computing and network metrics pre-collected from each MEC server function, and mobile underlay network metrics collected from a network data analytics function (NWDAF) from a serverless computing aware function (SCAF) included in a mobile core network, and determining serverless service instance deployment information including the number of pre-warming serverless service instances and one or more MEC servers on which the service instances are to be placed by using a serverless orchestration algorithm with reference to the metrics.

### Advantageous Effects

According to the present invention, there is an advantage in that serverless service instances can be prepared in advance at various MEC sites, and the mobile network control plane can direct UE requests to appropriate pre-warmed serverless service instances among MEC sites while knowing the pre-warmed serverless service instance deployment and maximum request serving capacity.

### DESCRIPTION OF DRAWINGS

These and/or other aspects will become apparent and more readily appreciated from the following description of the embodiments, taken in conjunction with the accompanying drawings in which:

FIG. 1 is a diagram illustrating MEC-related information of AF traffic impact request defined in 3GPP TS 23.501;

FIG. 2 is a diagram illustrating a proposed mobile edge architecture improvement configuration to support avoidance of serverless edge computing cold start problem according to the present embodiment;

FIGS. 3A to 3B are diagrams illustrating a process of applying a configuration according to the present embodiment to standardized 3GPP 5G and ETSI MEC architecture;

FIG. 4 is a diagram illustrating a process of providing periodic pre-warmed serverless deployment information to the proposed SCAF in MEC according to the present embodiment; and

FIGS. 5A to 5B are diagrams illustrating a PDU session establishment process for a serverless service request process according to the present embodiment.

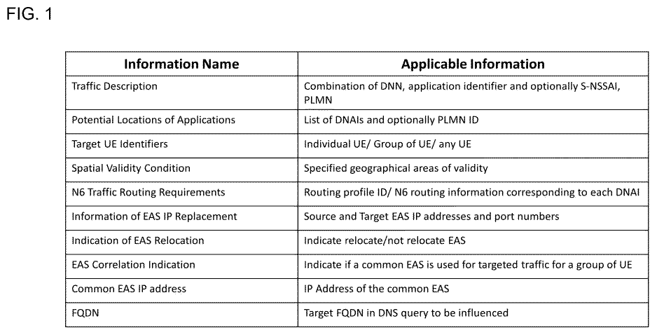

### DETAILED DESCRIPTION OF EMBODIMENTS

The present invention can have various modifications and various embodiments, and specific embodiments are illustrated in the drawings and described in detail in the detailed description. However, this is not intended to limit the present invention to specific embodiments, and it should be understood that it includes all modifications, equivalents, and substitutes included in the spirit and technical scope of the present invention.

The terms used in this specification are used only to describe specific embodiments and are not intended to limit the present invention. The singular expression includes the plural expression unless the context clearly indicates otherwise. In this specification, the terms “comprises” or “has” and the like are intended to specify the presence of a feature, number, step, operation, component, part, or combination thereof described in the specification, and should be understood not to exclude in advance the possibility of the presence or addition of one or more other features, numbers, steps, operations, components, parts, or combinations thereof.

In addition, the components of the embodiments described with reference to each drawing are not limited to the corresponding embodiments, and may be implemented to be included in other embodiments within the scope that the technical idea of the present invention is maintained, and it is also obvious that multiple embodiments may be re-implemented as one embodiment integrated even if a separate description is omitted.

In addition, when describing with reference to the attached drawings, the same components are given the same or related reference numerals regardless of the drawing numerals, and redundant descriptions thereof are omitted. In describing the present invention, if it is determined that a specific description of a related known technology may unnecessarily obscure the gist of the present invention, a detailed description thereof is omitted.

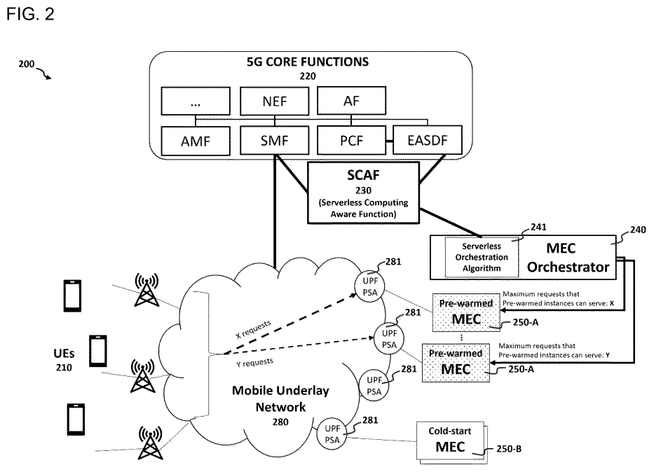

FIG. 2 is a diagram illustrating a serverless computing support configuration in a mobile network according to the present embodiment.

As illustrated in FIG. 2, the mobile network serverless edge computing traffic steering scenario 200 includes a UE 210, a mobile underlay network 280 including multiple user plane function PDU session anchors (UPF PSAs) 281, and multiple MEC servers 250.

Hereinafter, the MEC server is referred to as an MEC or MEC site.

In FIG. 2, an MEC hosting a pre-warmed serverless service instance is defined as a pre-warmed MEC 250-A, and an MEC not hosting a pre-warmed serverless service instance is defined as a cold start MEC 250-B.

In addition, the mobile network serverless edge computing traffic steering scenario includes an MEC orchestrator 240 hosting a serverless orchestration algorithm 241, a mobile core network function (5G CORE FUNCTION, hereinafter referred to as core network function) 220 and serverless computing aware function (SCAF) 230.

The UE 210 includes any wireless device that an end user uses to access a mobile network.

The UE 210 may comprise mobile devices such as smartphones, tablets, laptops, wearable devices, etc.

The UE 210 may be configured and installed with various types of serverless application clients. The UE 210 requests a serverless service deployed on the MEC 250 via the mobile underlay network 280 using the serverless application client.

The mobile underlay network 280 provides a user plane connection between the UE 210 and the MEC 250.

The core network function 220 configures and establishes a user plane path on the mobile underlay network 280 when the UE 210 requests a serverless service hosted on another MEC 250.

The user plane path from the UE 210 to each specific MEC 250 is fixed by a separate UPF PSA 281 within the mobile underlay network 280.

The core network function 220 includes network functions in the control plane of the 5th generation (5G) mobile communication network defined by ETSI 3GPP, such as access and mobility management function (AMF), session management function (SMF), policy control function (PCF), network exposure function (NEF), application function (AF), and edge application server discovery function (EASDF).

The MEC 250 is a variety of computing servers that can host services closer to the end user at the edge of the network.

In the implementation environment of the method described herein, the MEC 250 can be deployed based on the distributed mobile network connectivity model defined in the technical specification 23.548 of ETSI 3GPP. Each MEC 250 may be considered a local data network (DN) and may be anchored by a separate UPF PSA 281.

The service deployment life cycle and state inside each MEC are controlled and managed by the MEC platform manager.

Each MEC 250 may run a serverless deployment platform and host multiple serverless service instances. The serverless deployment platform allows access to serverless services even when no service instances are running inside the MEC site 250.

The MEC orchestrator 240 is an ETSI-defined orchestrator that can coordinate the service life cycle at the MEC site.

In the serverless edge computing scenario considered in this embodiment, the MEC orchestrator 240 hosts a serverless orchestration algorithm 241.

The serverless orchestration algorithm determines the number of required pre-warmed serverless service instances, their configurations, and optimal MEC site deployment.

The MEC orchestrator 240 requests the serverless orchestration algorithm 241 to pre-deploy the service on the selected MEC site.

The MEC site selected to host the pre-warmed serverless service instances is called a pre-warmed MEC 250-A, and the MEC site that is not selected is called a cold start MEC 250-B.

This is because when an UE 210 request arrives at such a MEC site, a new service instance is initialized, which causes a cold start problem. Different pre-warmed MECs 250 can host different numbers of pre-warmed serverless service instances according to the determination of the serverless orchestration algorithm 241. Therefore, the maximum request processing capacity is also different. When the maximum request processing capacity is exceeded, a new service instance is initialized.

The SCAF 230 can communicate and interact with the MEC orchestrator 240 and the core network function 220. The SCAF 230 manages the pre-warmed serverless instance deployment and provisioning function information. The core network function 220 cooperates with the SCAF 230 to load balance the serverless service request of the UE 210 according to the maximum request provisioning capacity among the various pre-warmed MECs 250.

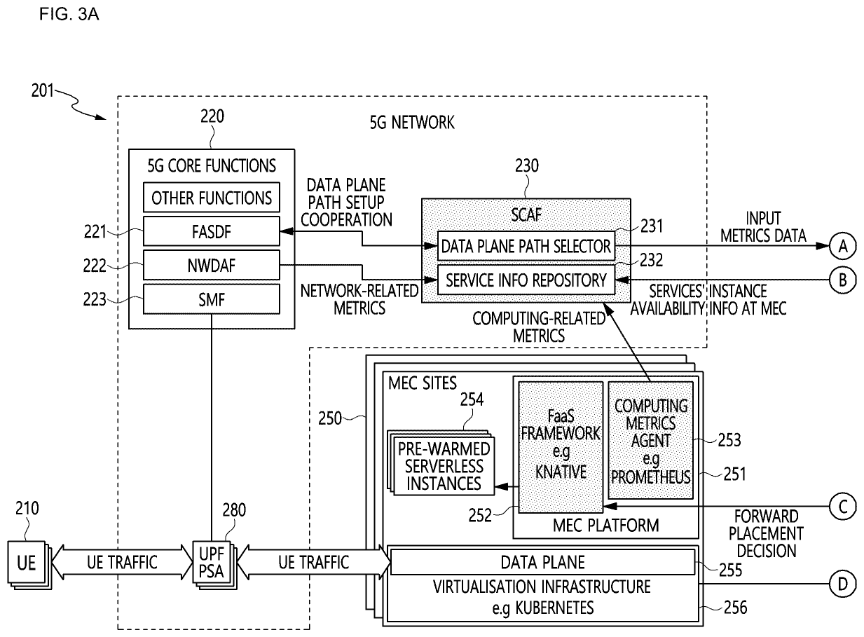

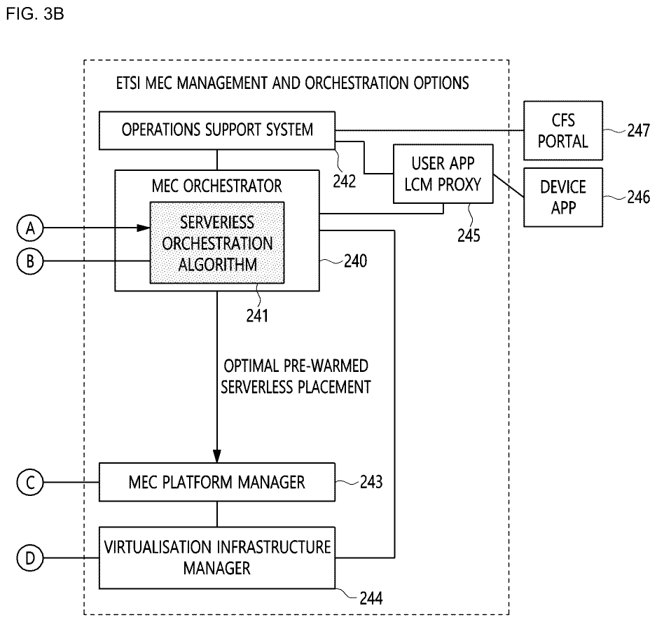

FIGS. 3A to 3B are diagrams illustrating a process of applying a configuration according to the present embodiment to a standardized 3GPP 5G and ETSI MEC architecture.

FIGS. 3A to 3B illustrate the detailed design and relationships of the added configuration and the currently standardized 3GPP 5G and ETSI MEC architectures.

The SCAF 230 includes a data plane path selector 231 and a service info repository 232.

The core network functions 220 related to the functions of the SCAF 230 are the EASDF 221, the network data analytics function (NWDAF) 222 and the SMF 223.

The standardized ETSI MEC architecture includes an MEC orchestrator 240, an operations support system 242, an MEC platform manager 243, a virtualization infrastructure manager 244, a user application lifecycle management proxy 245, a device application 246, and a customer-facing service portal 247.

The MEC orchestrator 240 is a central entity that has a holistic view of the distributed MEC environment and can determine and trigger MEC service initialization, redeployment, and termination across all MEC sites under its control.

The MEC platform manager 243 controls the service lifecycle, rules, and requirements under the direction of the MEC orchestrator 240.

Within each MEC 250, the MEC platform 251 hosts a Function as a Service (FaaS) framework 252 (e.g., Knative serverless framework) and a computing metrics agent 253 (e.g., Prometheus).

The MEC platform 251 can deploy pre-warmed serverless service instances 254.

The MEC 250 also includes a data plane 255 implemented in a virtualized infrastructure 256 (e.g., Kubernetes). UE serverless traffic is transported between the UE 210, the UPF PSA 280, and the data plane 255 of the MEC 250.

The SCAF 230 fills the orchestration gap between the MEC orchestrator 240 and the 5G control plane. It has two functions:

The first is a service information repository 232 that manages serverless service instance deployment and request delivery status, and computing and network metrics corresponding to each MEC site.

The second is a data plane path selector 231 that determines an appropriate MEC site to serve a UE request based on the managed information.

This communicates with the core network function 220 to configure the corresponding PDU session.

Meanwhile, the MEC platform 250 includes a FaaS framework 252 that deploys serverless service instances and provides serverless service management services at the MEC site. It deploys each serverless service instance inside a container of virtualization infrastructure 256. It also implements a management layer that provides abstract application life cycle, automatic scaling, and routing services.

In addition to the FaaS framework 252, the MEC platform 250 includes a computing metrics agent 253 that can obtain the current computing resource consumption and request provision status of the serverless service.

In relation to the interaction flow between components, the MEC orchestrator 240 provides the MEC platform manager 243 with an optimal pre-warmed serverless service instance deployment determined by the serverless orchestration algorithm 241.

Based on the deployment, the MEC platform manager 243 provides the pre-warmed serverless instructions to the MEC platform 251 of the corresponding MEC site 250.

These instructions trigger the FaaS framework 252 to perform an initialization or auto-scale-up procedure to prepare the required number of pre-warmed service instances. At the same time, the MEC orchestrator 240 also provides serverless service instance deployment information to the service information repository 232 of the SCAF 230.

The SCAF 230 also collects and manages computing and underlay network-related metrics corresponding to each MEC 250. The metrics include the current serverless service computing resource consumption and request serving status of the computing metrics agent 253 running internally in each MEC 250. Meanwhile, the metrics of the mobile underlay network can be provided by the NWDAF 222.

In addition, the SCAF 230 may provide information from the service information repository 232 as input data to the serverless orchestration algorithm 241. Meanwhile, the data plane path selector 231 and the EASDF 221 exchange the requested service, PDU session, and determined optimal MEC site information to establish the corresponding data plane routing path.

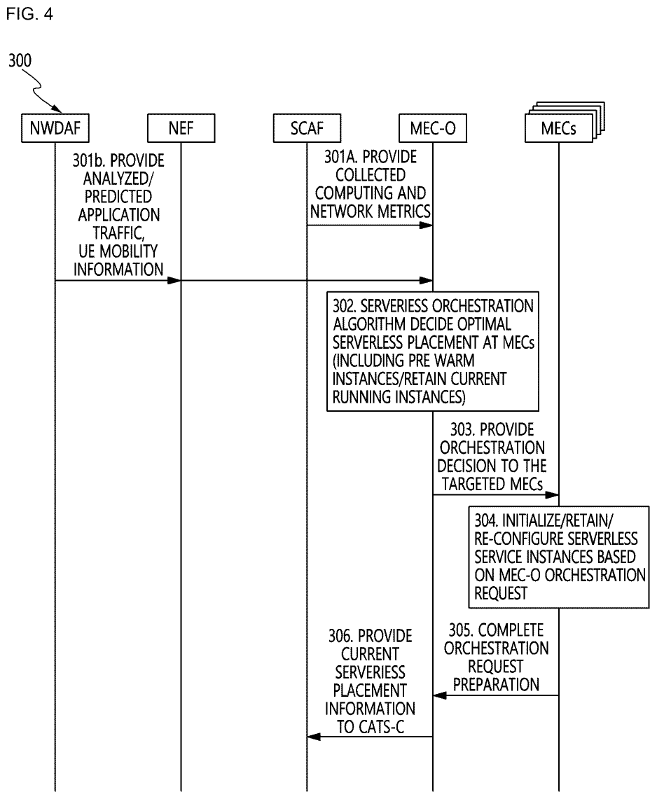

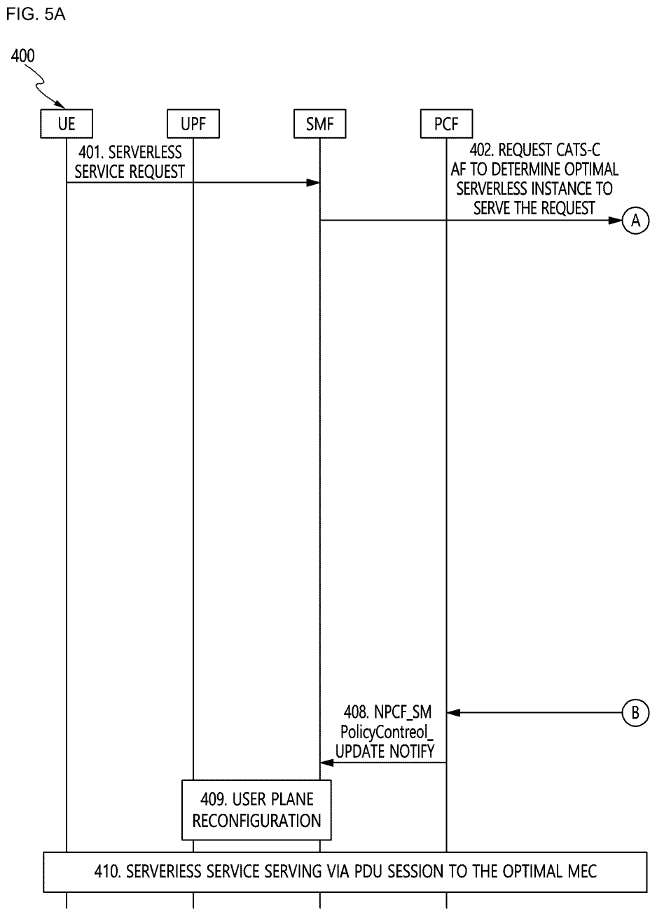

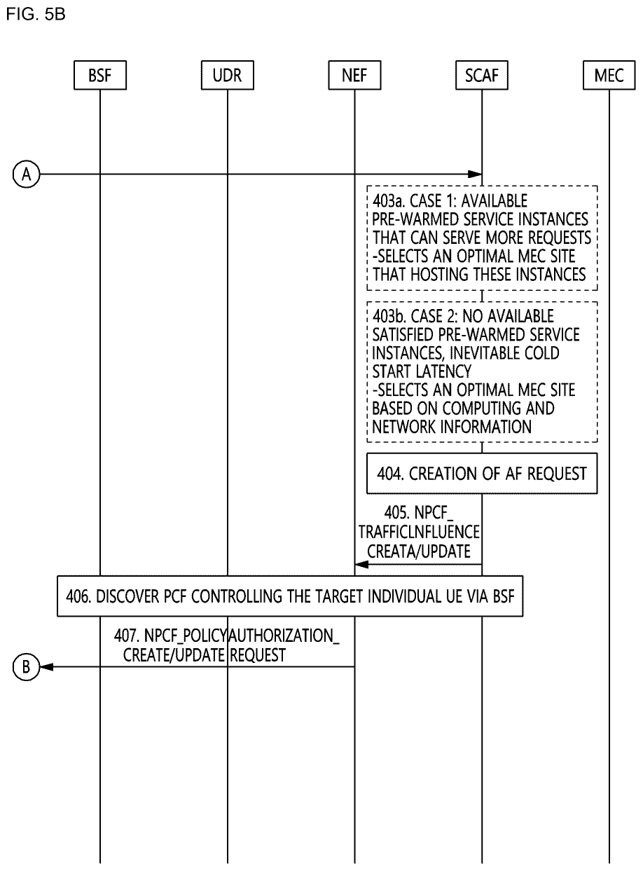

FIGS. 4 and 5 describe a 5G data plane setup procedure for a pre-warmed serverless service based on the above-described architectural improvements.

The procedure for providing periodic pre-warmed serverless deployment information and the procedure for establishing a PDU session for a serverless service request are illustrated.

First, referring to FIG. 4, through the periodic pre-warmed serverless deployment information provision process, the MEC orchestrator 240 can update the pre-warmed serverless service instance deployment information in the SCAF 230 whenever the serverless orchestration algorithm 241 determines a new deployment strategy.

In general, the serverless orchestration algorithm 241 can determine a pre-warmed service instance deployment strategy to prepare for future request traffic by using the requested traffic volume, UE location, and MEC site resource status prediction or mathematical analysis results as input data.

There are several ways to provide input data information to the algorithm 241 running inside the MEC orchestrator 240.

For example, the SCAF 230 transmits the computing and network metrics of each MEC site to the MEC orchestrator 240 (step 301a).

In addition, the NWDAF 222 transmits UE-related information and requests traffic prediction or analysis to the MEC orchestrator 240 through the SCAF 230 (step 301b).

Thereafter, the serverless orchestration algorithm 241 determines an optimal pre-warmed serverless service instance deployment strategy (step 302).

The MEC orchestrator 240 transmits the deployment information to the corresponding MEC site 250 through the MEC platform manager 243 (step 303).

The FaaS framework 252 running on the MEC site 250 performs the serverless service instance deployment task to prepare the required number of pre-warmed service instances 254 (step 304).

Next, the MEC orchestrator 240 provides the serverless service instance deployment information to the SCAF 230 after receiving the readiness confirmation from the MEC site 250 (step 305).

FIGS. 5A to 5B illustrate the PDU session establishment process whenever the UE 210 requests a serverless service.

Referring to FIGS. 5A to 5B, after the SMF 223 receives the PDU session establishment request for the serverless service (step 401), it requests the SCAF 230 to identify the target MEC site 250 to process the UE request (step 402). At step 502, the SMF 223 can provide the UE location and service domain name to the SCAF 230.

SCAF 230 determines the optimal destination by considering the computing resource consumption and request serving status information of the current serverless service updated by the computing metrics agent 253 at the MEC site 250 (step 403).

Two cases can occur depending on the request serving status of the currently running pre-warmed service instance (Case 1/Case 2). It is important to note that the maximum concurrent requests that each service instance can handle can be controlled by several serverless frameworks such as Knative.

The service provider can configure an appropriate maximum concurrent request value corresponding to the computing resources allocated to each service instance to prevent request-response delay.

Therefore, SCAF 230 can collect the current number of requests provided by the serverless service instance information and select an appropriate MEC site 250.

The first case, step 403a, is when there is a pre-warmed serverless service instance that can serve more requests available at several pre-warmed MEC sites 250-A. The SCAF 230 can select the optimal MEC site to serve the UE requests from these MEC sites.

The selection criteria can vary. One possible method is to select the MEC site hosting the service instance that currently provides the lowest traffic volume.

The second case, step 403b, is when there are no available pre-warmed serverless service instances that can receive more requests. This case can occur because traffic prediction is not always completely accurate. In this case, new service instance initialization is required and serverless cold start delays are inevitable.

The SCAF 230 should select the optimal MEC site based on current computing and network metrics associated with each MEC site 250.

An expected service delay calculation based on network bandwidth and computing resource consumption is a possible method to determine the MEC site.

After the target MEC site is determined, the SCAF 230 impacts the SMF 223 to configure the corresponding UPF PSA 280 and PDU session from step 405 to step 410, which is the original AF-based traffic impact procedure defined by 3GPP.

The service IP address representing all instances running on the selected MEC site can be retrieved from the MEC deployment information. The SMF 223 provides the information so that the UE 210 can access the service.

The method for supporting the avoidance of cold start serverless computing problems through the improvement of mobile edge network architecture described above can also be implemented in the form of a recording medium including program instructions executable by a computer, such as an application or program module executed by a computer. The computer-readable medium can be any available medium that can be accessed by a computer processor, and includes both volatile and nonvolatile media, removable and non-removable media. In addition, the computer-readable medium can include a computer storage medium. Computer storage media includes both volatile and nonvolatile, removable and non-removable media implemented in any method or technology for storing information such as computer-readable instructions, data structures, program modules or other data.

The above-described embodiments of the present invention have been disclosed for the purpose of illustration, and those skilled in the art with common knowledge of the present invention will be able to make various modifications, changes, and additions within the spirit and scope of the present invention, and such modifications, changes, and additions should be considered to fall within the scope of the following patent claims.

1. A method for supporting serverless computing in a mobile network, comprising:
transmitting, by a serverless computing aware function (SCAF) included in a mobile core network function, computing and network metrics pre-collected from each MEC server to an MEC orchestrator;
transmitting, by the SCAF, mobile underlay network metrics collected from a network data analytics function (NWDAF) to the MEC orchestrator;
determining, by the MEC orchestrator, serverless service instance deployment information including the number of pre-warming serverless service instances and one or more MEC servers on which the service instances are to be placed by using a serverless orchestration algorithm with reference to the metrics;
preparing, by the one or more MEC servers, serverless service instances according to the determined deployment information; and
exchanging, by an edge application server discovery function (EASDF) included in the function of the mobile core network, a PDU session and the deployment information with the SCAF in response to a serverless service request from a user equipment (UE), to establish a data plane routing path for the UE.

2. The method of claim 1, wherein the serverless orchestration algorithm determines pre-warmed service instance deployment information for preparing future request traffic by using a requested traffic volume, an UE location, and MEC site resource status prediction or mathematical analysis result as input data.

3. The method of claim 1, wherein the MEC orchestrator transmits the deployment information to the one or more MEC servers through a MEC platform manager, and
wherein the FaaS framework running on the one or more MEC servers performs a serverless service instance deployment task to prepare a required number of pre-warmed service instances.

4. The method of claim 1, wherein a session management function (SMF) included in the mobile core network function provides a location of the UE and service domain name to the SCAF after receiving a PDU session establishment request for a serverless service of the UE,
wherein the SCAF determines a destination by considering computing resource consumption and request provision status of a current serverless service updated by a computing metrics agent of each MEC server.

5. The method of claim 1, wherein the SCAF determines one of a plurality of MEC servers, in which a pre-warmed serverless service instance capable of providing more available requests is prepared, as a target MEC server.

6. The method of claim 1, wherein the SCAF determines a target MEC server to provide a serverless service to the UE by calculating an expected service delay based on network bandwidth and computing resource consumption when there is no MEC server prepared with pre-warmed serverless service instances capable of providing more available requests.

7. A system for supporting serverless computing in a mobile network comprising:
an MEC orchestrator that determines serverless service instance deployment information including the number of pre-warmed serverless service instances and one or more MEC servers on which the service instances are to be placed using a serverless orchestration algorithm; and
a serverless computing aware function (SCAF) included in a mobile core network function, and that transmits computing and network metrics pre-collected from each MEC server and mobile underlay network metrics collected from a network data analytics function (NWDAF) for determining the serverless service instance deployment information to the MEC orchestrator,
wherein the one or more MEC servers prepare serverless service instances according to the determined deployment information,
wherein an edge application server discovery function (EASDF) included in the mobile core network function exchanges a PDU session and the deployment information with the SCAF according to a serverless service request from a user equipment (UE), thereby establishing a data plane routing path for the UE.

8. The system of claim 7, wherein the serverless orchestration algorithm uses request traffic volume, UE location, and MEC site resource status prediction or mathematical analysis results as input data to determine pre-warmed service instance deployment information for preparing future request traffic.

9. The system of claim 7, wherein the MEC orchestrator transmits the deployment information to the one or more MEC servers through a MEC platform manager,
wherein the FaaS framework running on the one or more MEC servers performs a serverless service instance deployment task to prepare a required number of pre-warmed service instances.

10. The system of claim 7 further comprises,
a session management function (SMF) included in the mobile core network function, and that provides a location of the UE and service domain name to the SCAF after receiving a PDU session establishment request for the serverless service of the UE,
wherein the SCAF determines a destination by considering computing resource consumption and request provision status of a current serverless service updated by a computing metrics agent of each MEC server.

11. The system of claim 7, wherein the SCAF determines one of a plurality of MEC servers prepared with pre-warmed serverless service instances capable of providing more available requests as a target MEC server.

12. A serverless computing support apparatus in a mobile network comprising:
a processor; and
a memory connected to the processor,
wherein the memory comprises program instructions, executed by the processor, perform operations comprising,
receiving computing and network metrics pre-collected from each MEC server function, and mobile underlay network metrics collected from a network data analytics function (NWDAF) from a serverless computing aware function (SCAF) included in a mobile core network, and
determining serverless service instance deployment information including the number of pre-warming serverless service instances and one or more MEC servers on which the service instances are to be placed by using a serverless orchestration algorithm with reference to the metrics.
